(19) United States
(12) Patent Application Publication
(10) Pub. No.: US 2025/0011354 A1
(43) Pub. Date: Jan. 9, 2025

(54) Process for preparing diphosphites

(71) Applicant: Evonik Oxeno GmbH & Co. KG, Marl (DE)

(72) Inventors: Anna Chiara Sale, Düsseldorf (DE); Robert Franke, Marl (DE); Dirk Fridag, Haltern am See (DE); Peter Kucmierczyk, Herne (DE); Ana Markovic, Haltern am See (DE)

(73) Assignee: Evonik Oxeno GmbH & Co. KG, Marl (DE)

(21) Appl. No.: 18/754,793

(22) Filed: Jun. 26, 2024

(30) Foreign Application Priority Data
Jun. 27, 2023 (EP) 23181668.7

(51) Int. Cl. C07F 9/6574

(52) U.S. Cl. CPC C07F 9/65746

(57) ABSTRACT

Process for preparing diphosphites and the compounds used for the preparation.

The invention relates to a process for preparing diphosphites and to the compounds used for the preparation.

Diphosphites are classically prepared using Cl-containing compounds or via Cl-containing intermediates.

As described in WO 2012/095255 A1, chlorine residues from the synthesis remain in the diphosphite, which leads to problems when using the diphosphite, such as the formation of hydrogen chloride in the reactor. This has the consequence that diphosphites prepared using Cl-containing compounds have to be laboriously purified after synthesis in order to reduce the Cl content. However, even after laborious purification, Cl residues still remain in the diphosphite, which leads to problems with the further use of the compound.

The technical object of the invention is to provide a process in which the problems arising in relation to the prior art are reduced or eliminated.

The object is achieved by a process according to Claim 1.

Process comprising the process steps of:
a)

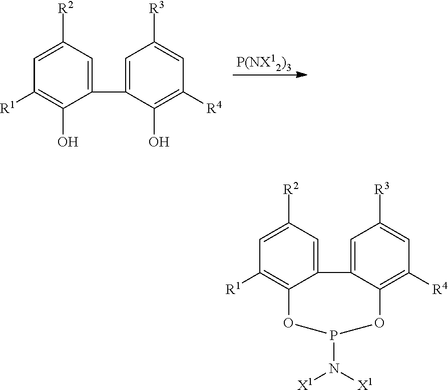

where R¹, R², R³, R⁴ are selected from: —H, —(C₁-C₁₂)-alkyl, —O—(C₁-C₁₂)-alkyl, —(C₆-C₁₀)-aryl, —CN, —NO₂ and X¹ is —(C₁-C₆)-alkyl;
b)

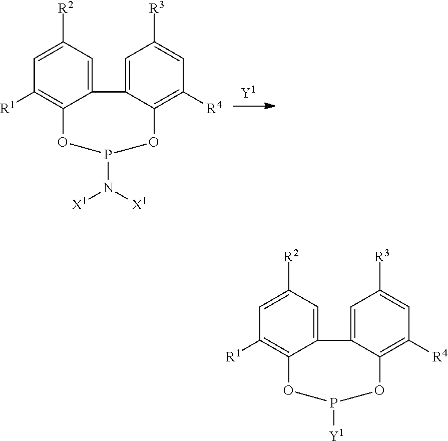

where Y¹ is a five-membered ring in which at least one carbon atom has been replaced by a nitrogen atom;
c)

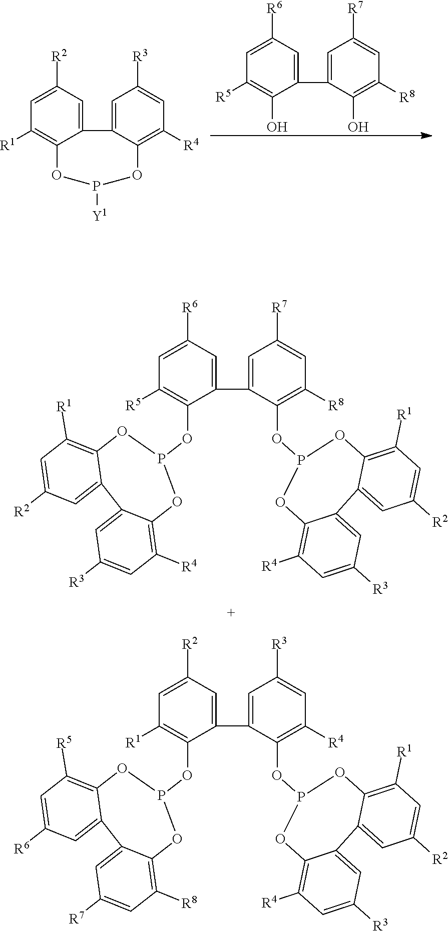

where R⁵, R⁶, R⁷, R⁸ are selected from: —H, —(C₁-C₁₂)-alkyl, —O—(C₁-C₁₂)-alkyl, —(C₆-C₁₀)-aryl, —CN, —NO₂.

Examples of a five-membered ring in which a carbon atom has been replaced by a nitrogen atom are:
pyrrolidine, 2-pyrroline, 3-pyrroline, azole.

Examples of a five-membered ring in which two carbon atoms have been replaced by nitrogen atoms are:
diazolidine, 1,2-diazole, 1,3-diazole.

Examples of a five-membered ring in which three carbon atoms have been replaced by nitrogen atoms are:
1,2,3-triazolidine, 1,2,4-triazolidine, 1,2,3-triazole, 1,2,4-triazole.

Examples of a five-membered ring in which four carbon atoms have been replaced by nitrogen atoms are:
tetrazolidine, 5H-tetrazole, 2,5-dihydro-1H-tetrazole.

An example of a five-membered ring in which five carbon atoms have been replaced by nitrogen atoms is:
1H-pentazole.

In one variant of the process, the five-membered ring (Y¹) has at least one double bond.

In one variant of the process, the five-membered ring (Y¹) has two double bonds.

In one variant of the process, the five-membered ring (Y¹) has at least one N—H bond.

In one variant of the process, the five-membered ring (Y¹) has at least two nitrogen atoms.

In one variant of the process, the five-membered ring (Y¹) has at least three nitrogen atoms.

In one variant of the process, the five-membered ring (Y¹) has four nitrogen atoms.

In one variant of the process, Y¹ is the following compound:

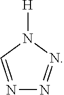

In one variant of the process, X¹ is —(C₁-C₂)-alkyl.

In one variant of the process, X¹ is —CH₂—CH₃.

In one variant of the process, X¹ is —CH₃.

In one variant of the process, R¹, R², R³, R⁴ are selected from: —H, —(C₁-C₁₂)-alkyl, —O—(C₁-C₁₂)-alkyl, —(C₆-C₁₀)-aryl.

In one variant of the process, R¹, R², R³, R⁴ are selected from: —(C₁-C₁₂)-alkyl, —O—(C₁-C₁₂)-alkyl.

In one variant of the process, R¹, R², R³, R⁴ are selected from: —CH₃, —O—CH₃, -t^{ert}Bu.

In one variant of the process, R⁵, R⁶, R⁷, R⁸ are selected from: —H, —(C₁-C₁₂)-alkyl, —O—(C₁-C₁₂)-alkyl, —(C₆-C₁₀)-aryl.

In one variant of the process, R⁵, R⁶, R⁷, R⁸ are selected from: —(C₁-C₁₂)-alkyl, —O—(C₁-C₁₂)-alkyl.

In one variant of the process, R⁵, R⁶, R⁷, R⁸ are selected from: —CH₃, —O—CH₃, -t^{ert}Bu.

In one variant of the process, this process comprises the additional process step d) of:
d) adding a solvent.

In one variant of the process, the solvent is selected from: acetonitrile (ACN), toluene, xylene, THF, heptane.

In one variant of the process, the solvent is acetonitrile (ACN).

In one variant of the process, the synthesis is performed in the absence of Cl.

In addition to the process itself, compounds which are used in the process are also claimed.

Compound of formula (I):

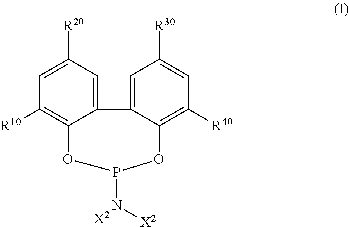

where R¹⁰, R²⁰, R³⁰, R⁴⁰ are selected from: —(C₁-C₁₂)-alkyl, —O—(C₁-C₁₂)-alkyl, —(C₆-C₁₀)-aryl, —CN, —NO₂ and X² is —(C₁-C₆)-alkyl.

In one embodiment, R¹⁰, R²⁰, R³⁰, R⁴⁰ are selected from: —(C₁-C₁₂)-alkyl, —O—(C₁-C₁₂)-alkyl.

In one embodiment, R¹⁰, R²⁰, R³⁰, R⁴⁰ are selected from: —CH₃, —O—CH₃, -t^{ert}Bu.

In one embodiment, X² is —(C₁-C₂)-alkyl.

In one embodiment, X² is —CH₂—CH₃.

In one embodiment, X² is —CH₃.

Compound of formula (II):

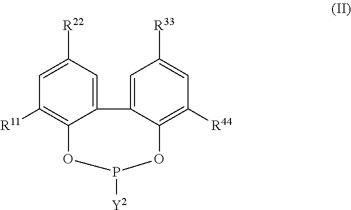

where R¹¹, R²², R³³, R⁴⁴ are selected from: —H, —(C₁-C₁₂)-alkyl, —O—(C₁-C₁₂)-alkyl, —(C₆-C₁₀)-aryl, —CN, —NO₂ and Y² is a five-membered ring in which at least one carbon atom has been replaced by a nitrogen atom.

In one embodiment, R¹¹, R²², R³³, R⁴⁴ are selected from: —H, —(C₁-C₁₂)-alkyl, —O—(C₁-C₁₂)-alkyl, —(C₆-C₁₀)-aryl.

In one embodiment, R¹¹, R²², R³³, R⁴⁴ are selected from: —(C₁-C₁₂)-alkyl, —O—(C₁-C₁₂)-alkyl.

In one embodiment, R¹¹, R²², R³³, R⁴⁴ are selected from: —CH₃, —O—CH₃, -t^{ert}Bu.

In one embodiment, the five-membered ring (Y²) has at least one double bond.

In one embodiment, the five-membered ring (Y²) has two double bonds.

In one embodiment, the five-membered ring (Y²) has at least one N—H bond.

In one embodiment, the five-membered ring (Y²) has at least two nitrogen atoms.

In one embodiment, the five-membered ring (Y²) has at least three nitrogen atoms.

In one embodiment, the five-membered ring (Y²) has four nitrogen atoms.

In one embodiment, Y² is the following radical:

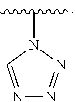 [SMILES: *n1cnnn1]

The invention is to be elucidated in more detail hereinafter with reference to working examples.

### Syntheses A) First Stage with —CH₂—CH₃

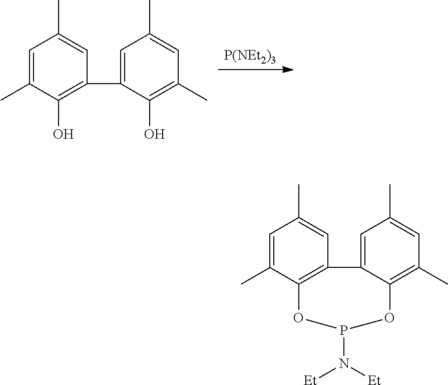

24.3 g (0.099 mol) of 3,3,5,5-tetramethyl-1,1-biphenol were weighed out in a 1000 ml Schlenk flask and dried over the course of 15 h by means of oil-pump vacuum. The next morning, the Schlenk flask was flooded with argon and the biphenol was dissolved in 400 ml of dried acetonitrile and 25 g (0.096 mol, 27.8 ml) of hexaethylphosphorous triamide (tris(diethylamido)phosphine). Subsequently, the solution was heated to 65° C. The reaction was completed after 4.5 hours. The reaction solution was cooled down to room temperature over the course of 15 h. The reaction solution was concentrated to dryness at 40° C. by means of oil-pump vacuum. Purity of the target product: 95%.

³¹P NMR results: 145.7 ppm.

### B) First Stage with —CH₃

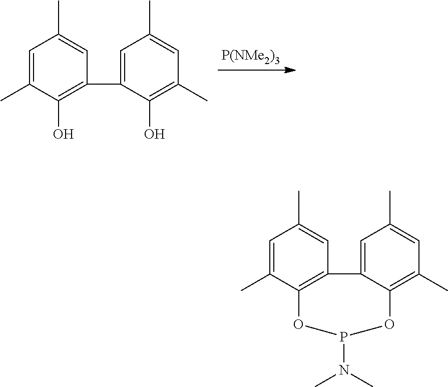

4.38 g (0.018 mol) of 3,3,5,5-tetramethyl-1,1-biphenol were weighed out in a 250 ml Schlenk flask and dried over the course of 15 h by means of oil-pump vacuum. The next morning, the Schlenk flask was flooded with argon and the biphenol was dissolved in 35 ml of dried acetonitrile and 3.12 g (0.018 mol, 3.5 ml) of hexamethylphosphorous triamide (tris(dimethylamido)phosphine). During the reaction, a gentle stream of argon was passed over in order to dissipate the dimethylamine formed. The reaction was left to stir at room temperature. The reaction was completed after 5 hours. The reaction solution was left at room temperature for 15 h. The reaction solution was concentrated to dryness at 40° C. by means of oil-pump vacuum. Purity of the target product: 96%.

³¹P NMR results: 145.2 ppm.

### C) Conversion to the Diphosphite

### EXAMPLE 1

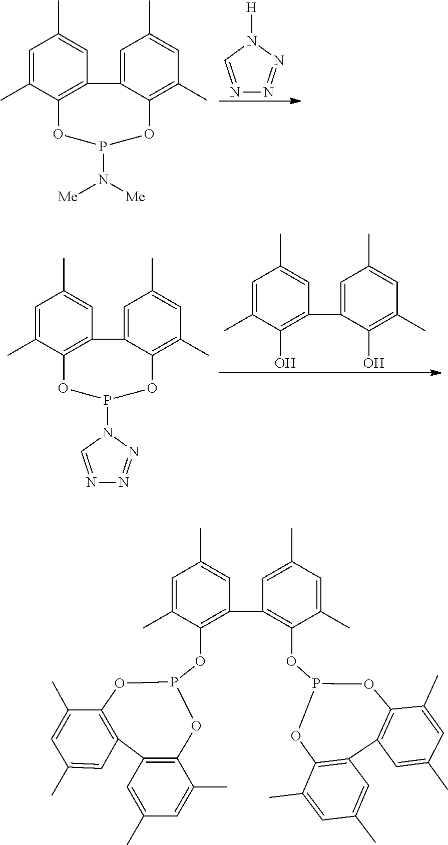

In a glovebox, 5.7 g (0.018 mol) of the starting compound were weighed out in a 250 ml, discharged and 52 ml (1.64 g, 0.0234 mol) of 0.45 M tetrazole-ACN solution was added using an argon-flushed syringe. This gave a suspension. Subsequently, the reaction solution was heated to 60° C. under a gentle argon flow. After 2 hours, the reaction solution was cooled down to room temperature and was allowed to react further over the course of 15 h with a gentle stream of argon. Subsequently, another 20 ml of dried ACN was added.

NMR results: ³¹P NMR 135.8 ppm.

2.4 g (0.010 mol) of 2,2′-bis(3,5-dimethylphenol) were weighed out in a 50 ml Schlenk flask, dried over the course of 15 h and then flooded with argon. Subsequently, the biphenol was added in portions at room temperature in an opposing flow of argon to the 0.022 molar (7.4 g) ACN-tetrazole ligand reaction solution and left to stir at 60° C. for 15 h. The next morning, the reaction solution was cooled down to 0° C., filtered off on a frit, washed twice with 10 ml of dried cold ACN and the frit was dried.

Purity of target product: 93%.

³¹P NMR 142.9 ppm.

### EXAMPLE 2

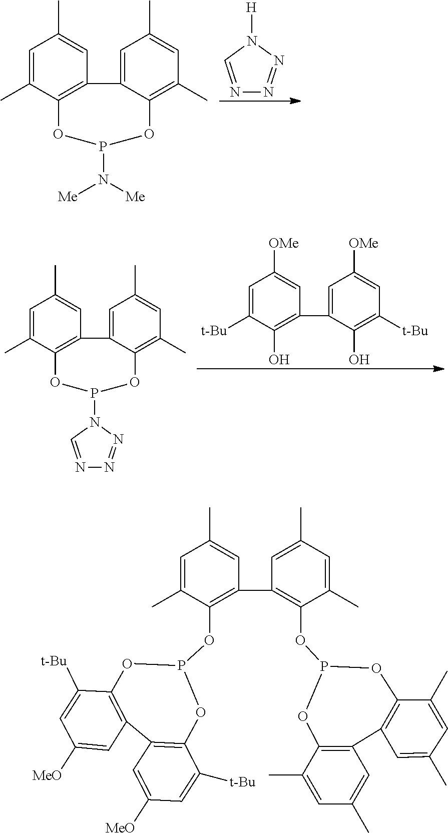

In a glovebox, 5.7 g (0.018 mol) of the starting compound were weighed out in a 250 ml, discharged and 52 ml (1.64 g, 0.0234 mol) of 0.45 M tetrazole-ACN solution was added using an argon-flushed syringe. This gave a suspension. Subsequently, the reaction solution was heated to 60° C. under a gentle argon flow. After one hour, 3.46 g (0.010 mol) of 5,5′-dimethoxy-3,3′-di-tert-butyl-2,2′-biphenol were weighed out, discharged and poured in portions in an opposing flow of argon into the current (0.018 mol) ACN-tetrazole ligand reaction solution. Thereafter, the reaction solution was allowed to gradually come to room temperature and allowed to react over the course of 15 h. Subsequently, the solids were filtered off on a frit, washed twice with 10 ml of dried ACN, and dried. Purity of target product: 83%.

³¹P NMR 142.0, 141.1 ppm.

The novel synthesis route makes it possible to dispense with Cl-containing compounds. Firstly this eliminates the laborious purification of the diphosphite after synthesis, and secondly the introduction of residual Cl into the reactor is also avoided.

1. Process comprising the process steps of:
a) 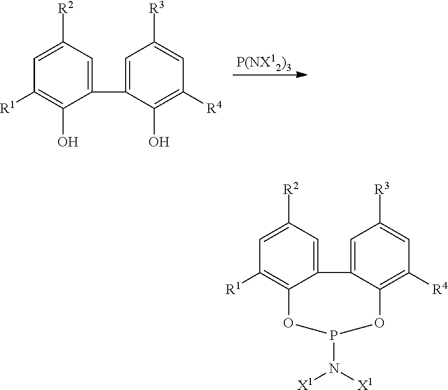
where R¹, R², R³, R⁴ are selected from: —H, —(C₁-C₁₂)-alkyl, —O—(C₁-C₁₂)-alkyl, —(C₆-C₁₀)-aryl, —CN, —NO₂ and X¹ is —(C₁-C₆)-alkyl;
b) 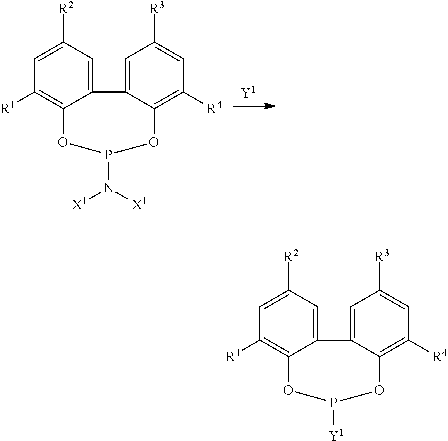
where Y¹ is a five-membered ring in which at least one carbon atom has been replaced by a nitrogen atom;
c) 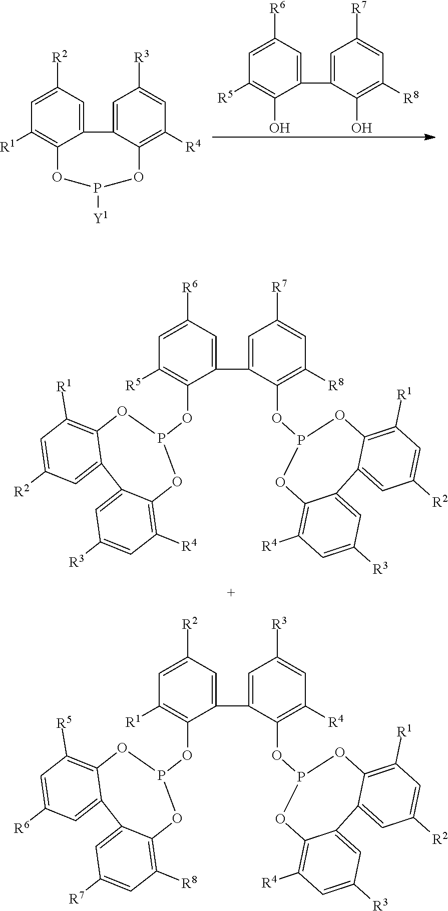
where R⁵, R⁶, R⁷, R⁸ are selected from —H, —(C₁-C₁₂)-alkyl, —O—(C₁-C₁₂)-alkyl, —(C₆-C₁₀)-aryl, —CN, —NO₂.

2. Process according to claim 1,
where the five-membered ring has at least one double bond.

3. Process according to claim 1,
where the five-membered ring has at least one N—H bond.

4. Process according to claim 1,
where Y¹ is the following compound:

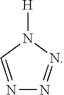

5. Process according to claim 1,
where X¹ is —(C₁-C₂)-alkyl.

6. Process according to claim 1,
where R¹, R², R³, R⁴ are selected from: —H, —(C₁-C₁₂)-alkyl, —O—(C₁-C₁₂)-alkyl, —(C₆-C₁₀)-aryl.

7. Process according to claim 1,
where R¹, R², R³, R⁴ are selected from: —(C₁-C₁₂)-alkyl, —O—(C₁-C₁₂)-alkyl.

8. Process according to claim 1,
where R⁵, R⁶, R⁷, R⁸ are selected from: —H, —(C₁-C₁₂)-alkyl, —O—(C₁-C₁₂)-alkyl, —(C₆-C₁₀)-aryl.

9. Process according to claim 1,
where R⁵, R⁶, R⁷, R⁸ are selected from: —(C₁-C₁₂)-alkyl, —O—(C₁-C₁₂)-alkyl.

10. Process according to claim 1, comprising the additional process step d) of:
d) adding a solvent.

11. Process according to claim 10,
where the solvent is selected from: acetonitrile (ACN), toluene, xylene, THF, heptane.

12. Compound of formula (I): 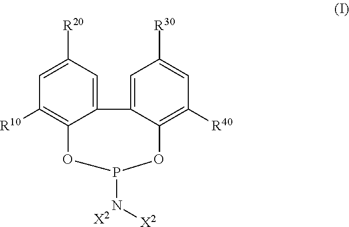
where R¹⁰, R²⁰, R³⁰, R⁴⁰ are selected from: —(C₁-C₁₂)-alkyl, —O—(C₁-C₁₂)-alkyl, —(C₆-C₁₀)-aryl, —CN, —NO₂ and X² is —(C₁-C₆)-alkyl.

13. Compound according to claim 12,
where R¹⁰, R²⁰, R³⁰, R⁴⁰ are selected from: —(C₁-C₁₂)-alkyl, —O—(C₁-C₁₂)-alkyl.

14. Compound of formula (II): 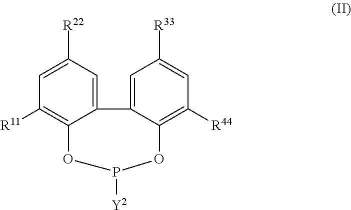
where R¹¹, R²², R³³, R⁴⁴ are selected from: —H, —(C₁-C₁₂)-alkyl, —O—(C₁-C₁₂)-alkyl, —(C₆-C₁₀)-aryl, —CN, —NO₂ and Y² is a five-membered ring in which at least one carbon atom has been replaced by a nitrogen atom.

15. Compound according to claim 14,
where Y² is the following radical: 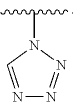 [SMILES: *n1cnnn1]
